(19) United States
(12) Patent Application Publication
(10) Pub. No.: US 2025/0341616 A1
(43) Pub. Date: Nov. 6, 2025

(54) LIDAR DEVICE AND VEHICLE

(71) Applicant: AUTOX TECH PTE. LTD., SINGAPORE (SG)

(72) Inventors: Zhuo Li, Shenzhen (CN); Jianxiong Xiao, Shenzhen (CN); Yizhou Shan, Shenzhen (CN)

(73) Assignee: AUTOX TECH PTE. LTD., SINGAPORE (SG)

(21) Appl. No.: 19/191,321

(22) Filed: Apr. 28, 2025

(30) Foreign Application Priority Data
May 6, 2024 (CN) 202410551063X
Jun. 3, 2024 (CN) 2024107109009

(51) Int. Cl. G01S 7/481; G01S 17/931

(52) U.S. Cl. CPC G01S 7/4817; G01S 7/4813; G01S 17/931

(57) ABSTRACT

The disclosure provides a LiDAR device, including: a transceiver, configured to emit primary beams, and detect echo beams formed by the primary beams' reflection from objects; a rotating component with a window, enabling the transceiver to emit the primary beams outward and receive echo beams through the window; a driver, rotatably coupled to the rotating component; wherein when the transceiver terminates operation, the driver actuates the rotating component to a predetermined position, so as to enable a protective device to shield the window. The disclosure further provides a vehicle.

### CROSS REFERENCE TO RELATED APPLICATION

This non-provisional patent application claims priority under 35 U. S. C. § 119 from Chinese Patent Application No. 202410551063.X, filed on May 6, 2024; and Chinese Patent Application No. 202410710900.9 filed on Jun. 3, 2024, the entire content of which is incorporated herein by reference.

### TECHNICAL FIELD

The disclosure relates to the field of automotive radar technology, particularly to a LiDAR device and a vehicle.

### BACKGROUND

Nowadays, multiple types of LiDARs are used on autonomous vehicles. When the vehicle is not in use, the rotating components of the LiDARs may randomly stop in any orientation due to the loss of motor control and can be freely rotated by external forces in a non-operating state. For example, in the optical detection method of a mechanically rotating LiDAR, there is an optical window on the surface of the LiDAR for transmitting laser beams. This optical window needs to be kept as clean and undamaged as possible. If the stationary orientation of the window exposes it to a high-risk environment when the LiDAR is stationary, it is highly likely to damage the optical window, causing the LiDAR to malfunction or even fail.

In summary, to maintain the LiDAR in optimal condition, a locking device that can protect the LiDAR needs to be designed to reduce the probability of damage or contamination to the LiDAR in a non-operating state.

### SUMMARY

The disclosure provides a LiDAR device and a vehicle, which can fulfill the need to protect the LiDAR of the vehicle and reduce the probability of damage or contamination to the LiDAR in a non-operating state.

In a first aspect, an embodiment of the disclosure provides a LiDAR device, including: a transceiver, configured to emit primary beams, and detect echo beams formed by the primary beams' reflection from objects; a rotating component with a window, enabling the transceiver to emit the primary beams outward and receive echo beams through the window; a driver, rotatably coupled to the rotating component; and a controller, configured to generate detection signals and locking signals to the driver and the transceiver; wherein: when the driver and the transceiver receive the detection signals, the transceiver activates operation while the driver driving the rotating component to rotates; when the driver and the transceiver receive the locking signals, the transceiver terminates operation while the driver actuates the rotating component to a predetermined position, so as to enable a protective device to shield the window when the driver and the transceiver device receive the locking signals, the transceiver device stops operating, and the rotating component rotates to a predetermined position under the drive of the driver so that the viewport is shielded by a protective device.

In a second aspect, an embodiment of the disclosure provides a vehicle including a vehicle body, and a LiDAR device disposed on the vehicle body, characterized by the LiDAR device including: a transceiver, configured to emit primary beams, and detect echo beams formed by the primary beams' reflection from objects; a rotating component with a window, enabling the transceiver to emit the primary beams outward and receive echo beams through the window; a driver, rotatably coupled to the rotating component; and a controller, configured to generate detection signals and locking signals to the driver and the transceiver; wherein: when the driver and the transceiver receive the detection signals, the transceiver activates operation while the driver driving the rotating component to rotates; when the driver and the transceiver receive the locking signals, the transceiver terminates operation while the driver actuates the rotating component to a predetermined position, so as to enable the protective device to shield the window.

The aforementioned vehicle and the LiDAR device disposed on the vehicle body effectively protect the LiDAR through the protective device on the side of the vehicle body and the protective device integral to the LiDAR device on the top of the vehicle body. When the vehicle is not in use, the rotating mechanism, driver, controller, and locking mechanism of the LiDAR device of the disclosure operate in conjunction, enabling the viewport of the LiDAR to face the protective device and shield it from high-risk environments, thereby reducing the probability of damage or contamination to the viewport of the LiDAR and extending the service life of the LiDAR.

### BRIEF DESCRIPTION OF THE DRAWINGS

To more clearly illustrate the technical solutions in the embodiments of the disclosure or in the prior art, the following provides a brief introduction to the drawings required for describing the embodiments or the prior art. It is apparent that the drawings described below are merely some embodiments of the disclosure. For those skilled in the art, other drawings can be obtained based on the structures shown in these drawings without exercising inventive effort.

FIG. 1 is a schematic diagram of a portion of a LiDAR device in accordance with an embodiment.

FIG. 2 is a schematic diagram of a vehicle in accordance with an embodiment.

FIG. 3 is a schematic diagram of a mechanical LiDAR in accordance with an embodiment.

FIG. 4 is a schematic diagram illustrating an operating state of the LiDAR on the vehicle in accordance with an embodiment.

FIG. 5 is a schematic diagram illustrating a static state of the LiDAR on a vehicle in accordance with an embodiment.

### DETAILED DESCRIPTION OF THE EMBODIMENTS

In order to make the purpose, technical solution, and advantages of this application clearer and clearer, the following will provide further detailed explanations of this application in conjunction with the accompanying drawings and embodiments. It should be understood that the specific embodiments described here are only intended to explain the disclosure and are not intended to limit the disclosure. Based on the embodiments in this application, all other embodiments obtained by ordinary technical personnel in this field without creative labor fall within the scope of protection of this application.

The terms “first,” “second,” “third,” “fourth,” etc. (if present) in the specification, claims, and accompanying drawings of the disclosure are used to distinguish similar planning objects and are not necessarily used to describe a specific sequence or order. It should be understood that such terms, when used, may be interchangeable under appropriate circumstances. In other words, the described embodiments may be implemented in an order other than that illustrated or described herein. Furthermore, the terms “include” and “have” and any variations thereof may also encompass additional content. For example, a process, method, system, product, or device comprising a series of steps or units is not limited to only those steps or units clearly listed but may include other steps or units not clearly listed or inherent to those processes, methods, products, or device.

It is important to note that the descriptions involving “first,” “second,” etc., in the disclosure are solely for descriptive purposes and should not be understood as indicating or implying their relative importance or implicitly specifying the number of indicated technical features. Therefore, features qualified by “first,” “second,” etc., may explicitly or implicitly include one or more of such features. In addition, the technical solutions among the various embodiments may be combined with each other, but this must be based on the ability of ordinary skilled artisans in the field to achieve such combinations. When the combination of technical solutions contradicts each other or cannot be implemented, such combinations should be deemed non-existent and not within the scope of protection claimed in the disclosure.

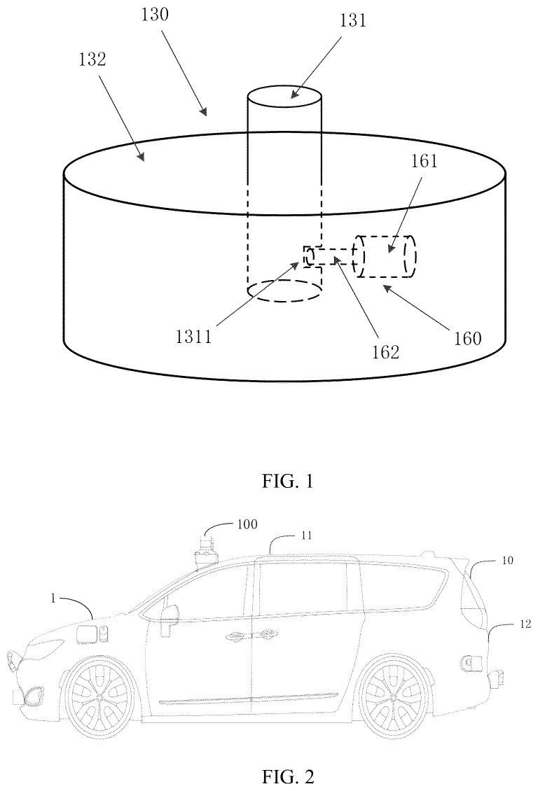

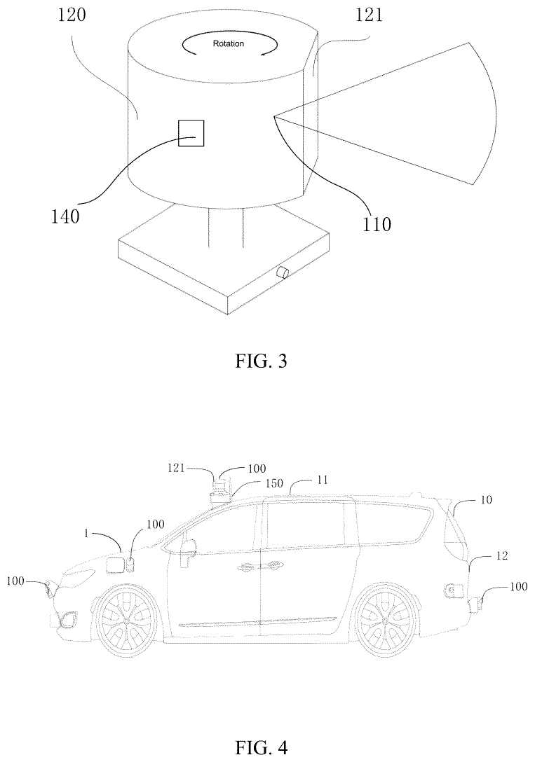

Referring to FIGS. 1 to 3, FIG. 1 is a schematic diagram of a portion of a LiDAR device in accordance with an embodiment. FIG. 2 is a schematic diagram of a vehicle in accordance with an embodiment. FIG. 3 is a schematic diagram of a mechanical LiDAR in accordance with an embodiment. The LiDAR device 100 provided in the embodiments of the disclosure can be applied to vehicles, ships, drones, robots, etc. The LiDAR device 100 includes a transceiver 110, a rotating portion 120, a driver 130, a controller 140, a protective device 150, and a locking mechanism 160. The transceiver 110 is configured to emit primary beams, and detect echo beams formed by the primary beams' reflection from objects. The rotating portion 120 is provided with a viewport 121 through which the transceiver 110 emits the primary beams to outward and receives the echo beams returned from the primary beams. The driver 130 is rotatably coupled to the rotating portion 120. The controller 140 is configured to generate a detection signal and a locking signal to the driver 130 and the transceiver 110. When the driver 130 and the transceiver 110 receive the detection signal, the transceiver 110 operates and the driver 130 drives the rotating portion 120 to rotate. When the driver 130 and the transceiver 110 receive the locking signal, the transceiver 110 terminates operation, and the rotating portion 120, driven by the driver 130, rotates to a predetermined position so that the viewport 121 is shielded by the protective device 150.

In this embodiment, the LiDAR is a mechanical LiDAR with a mechanical rotating structure, which includes a fully mechanical rotating LiDAR, a semi-solid mechanical scanning LiDAR, and the like. The LiDAR can determine the distance and position of obstacles relative to a target by emitting laser beams and receiving the reflected laser beams.

The rotating mechanism 120 includes a motor (not shown in the figure), which drives the rotating component 120 to rotate when the transceiver 110 is in operation and drives the rotating component 120 to rotate to a predetermined position when the transceiver 110 stops operating. Specifically, after being energized, the motor begins to operate and can be controlled based on speed or angle to drive the rotating component 120 to rotate during the operation of the transceiver 110 and to rotate the rotating component 120 to lock at the predetermined position when the transceiver 110 stops operating.

The driver 130 comprises a rotor 131 and a stator housing 132, with the rotor 131 rotatably coupled to the rotating component 120 and rotating relative to the stator housing 132 under the drive of the driver 130. Specifically, the rotor 131 is provided with a locking portion 1311, which has a locking slot that enables the rotating component 120 to rotate and fix at the predetermined position.

In this embodiment, the protective device 150 is disposed on the LiDAR device 100, meaning that the LiDAR device 100 comes with the protective device 150. In some feasible embodiments, the protective device 150 can also be installed on a product where the LiDAR device 100 is applied, or belong to a part of an object where the LiDAR device 100 is located. For example, when the LiDAR device 100 is applied to a vehicle, the protective device 150 can be the vehicle body. As another example, when the LiDAR device 100 is applied to a vehicle and located on the vehicle roof, the protective device 150 can be a protective cover disposed on the vehicle roof. The protective device 150 is a panel disposed on the LiDAR device for protecting the window. Specifically, the panel is rectangular with rounded corners and installed within a protective cover to form the protective device 150. The protective device 150 protects the window 121 from being damaged by the external environment when the LiDAR is not in operation, thereby extending the service life of the LiDAR. The material of the panel protecting the LiDAR window can be FLOMC laser protective board, which can effectively protect and filter laser in specific wavelength bands that match the wavelength bands of laser emitted and received by the transceiver 110. Moreover, the functional layer of the FLOMC laser protective board has high abrasion resistance, chemical resistance, and flame retardancy.

The locking mechanism 160 is disposed within the stator housing 132 and is used to lock the rotating component 120 at the predetermined position, thereby preventing the window 121 from being exposed to and damaged by the external environment. The locking mechanism 160 comprises a driver 161 and a retractable rod 162. The driver 161 is a linear motor of the locking mechanism and is used to drive the retractable rod to extend and retract along the horizontal direction. The driver 161 drives the retractable rod 162 to extend and retract, cooperating with the locking portion 1311 to lock the rotating component 120 and position it at the predetermined position. That is, when the locking slot is inserted by the retractable rod, the driver 130 stops rotating, causing the rotating component 120 to rotate to the predetermined position. The locking mechanism 160 operates after all moving parts of the LiDAR have completely stopped, protecting the LiDAR from accidental damage in a static state. The locking mechanism 160 is released before all moving parts of the LiDAR need to operate again, allowing the LiDAR to smoothly enter the operating state.

The above-mentioned locking mechanism 160 is a structure that realizes rotor locking through a latch form. After rotating the rotor 131 to the predetermined position through the linear motor of the locking mechanism, the linear motor can push the retractable rod 162 to the rotor locking slot, at which point the rotor 131 will remain fixed in orientation in the non-operating state. The locking mechanism can also be realized through another mechanism, such as a brake lock.

In this embodiment, firstly, when the LiDAR is in the operating state, the window 121 of the LiDAR device 100 rotates via the rotating component 120 to face the external environment. The LiDAR emits primary beams through the window 121 and receives returned echo beams, transmitting the detected information to the controller 140. The controller 140 generates a detection signal to the transceiver 110. When the driver 130 and the transceiver 110 receive the detection signal, the transceiver 110 operates and the driver 130 drives the rotation of the rotating component 120. At this point, the LiDAR can accurately map the three-dimensional image of the surrounding environment and precisely locate the specific position and distance of obstacles. When the LiDAR is in the non-operating state, the LiDAR rotates to a predetermined position, with the window 121 of the LiDAR device 100 rotating via the rotating component 120 to face the protective device 150. The driver 130 and the transceiver 110 receive a locking signal, causing the transceiver 110 to cease operation and the driver 130 to drive the motor of the rotating component 120 to rotate. After the motor rotates to the predetermined position, the rotating component 120 stops rotating. At this time, the protective device 150 of the vehicle body itself can be utilized to shield the window 121 of the rotating component 120, preventing the window 121 from being exposed to the external environment and damaged, thereby protecting the LiDAR. In addition, the protective device 150 that comes with the LiDAR device 100 can also be used to protect the LiDAR. That is, the rotor 131 of the driver 130 rotates to a predetermined position relative to the stator housing 132 under the drive of the driver 130, with the window 121 facing the protective device 150, and the driver 130 stops rotating. The driver 161 of the locking mechanism drives the retractable rod 162 to extend or retract and pushes the retractable rod into a locking slot, locking the rotating component 120 so that the rotating component 120 is positioned and fixed at the predetermined position. The protective device 150 of the LiDAR device 100 shields the window 121 of the rotating component 120, preventing the window 121 from being exposed to the external environment and damaged, thereby protecting the LiDAR.

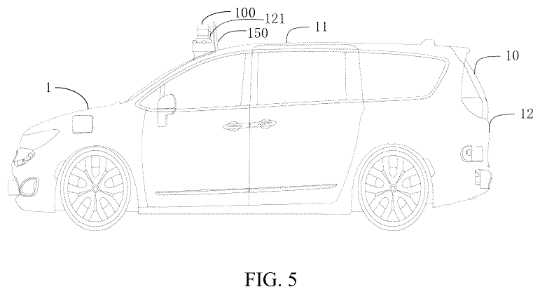

Referring to FIGS. 2, 4, and 5, FIG. 2 is a schematic diagram of a vehicle provided in an embodiment of this application. FIG. 4 is a schematic diagram of the operating state of the LiDAR on a vehicle provided in an embodiment of this application. FIG. 5 is a schematic diagram of the static state of the LiDAR on a vehicle provided in an embodiment of this application. An embodiment of the disclosure also provides a vehicle 1, comprising a vehicle body 10 and a LiDAR device 100 disposed on the vehicle body 10. The LiDAR device 100 can be installed on the top (roof) 11 and the side 12 of the vehicle body 10. Specifically, the LiDAR device 100 can be installed on the front and rear bumpers, headlights, hood, and other sides of the vehicle.

In this embodiment, when the LiDAR device 100 is installed on the top 11 of the vehicle body 10, the LiDAR is protected by the protective device 150 that comes with the LiDAR device 100. That is, the LiDAR is fixedly rotated to a predetermined position, so that the window 121 faces and is protected by the protective cover of the protective device 150. Specifically, when the vehicle is in motion, the LiDAR begins to operate, with the window 121 rotating via the rotating component 120 to face the external environment, as shown in FIG. 4. The LiDAR emits primary beams through the window 121 and receives returned echo beams, with the controller 140 generating a detection signal to the transceiver 110, accurately mapping the three-dimensional image of the surrounding environment and precisely locating the specific position and distance of obstacles. When the vehicle is in the non-operating state, the LiDAR rotates to a predetermined position, i.e., the window 121 faces the protective device 150 of the LiDAR device 100 disposed on the top 11 of the vehicle body 10. At this time, the rotor 131 of the driver 130 rotates to a predetermined position relative to the stator housing 132 under the drive of the driver 130, and the driver 130 stops rotating. The driver 161 of the locking mechanism drives the retractable rod 162 to extend or retract and pushes the retractable rod into a locking slot, locking the rotating component 120 so that the rotating component 120 is positioned and fixed at the predetermined position. The protective device 150 of the LiDAR device 100 shields the window 121 of the rotating component 120, hiding the window 121, as shown in FIG. 5. The window 121 is prevented from being exposed to the external environment and damaged, thereby protecting the LiDAR. When the vehicle is driven again, the LiDAR begins to rotate and enters the operating state once more.

In this embodiment, when the LiDAR device 100 is mounted on the side 12 of the vehicle body 10, the LiDAR begins to operate when the vehicle is in motion. Specifically, the window 121 of the LiDAR device 100 rotates to face the external environment, as shown in FIG. 4. The LiDAR emits laser beams through the window 121 and receives returning echo beams, and the controller 140 generates detection signals to the transceiver 110, accurately mapping the three-dimensional image of the surrounding environment and precisely locating the specific positions and distances of obstacles. When the vehicle is not in operation, the LiDAR rotates to a predetermined position, where the window 121 faces the protective device 150 on the side 12 of the vehicle body 10. The driver 120 and the transceiver 110 receive a locking signal to fix the LiDAR at the predetermined position, and the rotating component stops rotating. At this point, the protective device 150 of the vehicle body itself is used to shield the window 121 of the rotating component 120, as shown in FIG. 5. The window 121 is prevented from being exposed to the external environment and damaged, thereby protecting the LiDAR. When the vehicle is driven again, the LiDAR begins to rotate and enters the operating state once more.

The aforementioned vehicle and the LiDAR device installed on the vehicle body provide excellent protection for the LiDAR through the protective device on the side of the vehicle body and the protective device integral to the LiDAR device on the top of the vehicle body. During periods when the vehicle is not in use, the rotating mechanism, driver, controller, and locking mechanism of the LiDAR device of the disclosure cooperate to enable the window of the LiDAR to face the protective device and shield it from exposure to high-risk environments, reducing the probability of damage or contamination of the LiDAR window and thereby extending the service life of the LiDAR. When the vehicle is operational again, the LiDAR device allows the LiDAR window to rotate to the predetermined position, emit laser beams, and receive reflected laser beams.

It is evident that those skilled in the art can make various modifications and variations to this application without departing from the spirit and scope of this application. Thus, if such modifications and variations fall within the scope of the claims of this application and their equivalent technologies, this application is also intended to include these modifications and variations.

The examples listed above are merely preferred embodiments of this application and should not be used to limit the scope of the claims of this application. Therefore, equivalent variations made according to the claims of this application still fall within the scope covered by this application.

1. A LIDAR device, comprising:
a transceiver, configured to emit primary beams, and detect echo beams formed by the primary beams' reflection from objects;
a rotating component with a window, enabling the transceiver to emit the primary beams outward and receive the echo beams through the window;
a driver, rotatably coupled to the rotating component; and
a controller, configured to generate detection signals and locking signals to the driver and the transceiver; wherein:
when the driver and the transceiver receive the detection signals, the transceiver activates operation while the driver driving the rotating component to rotates;
when the driver and the transceiver receive the locking signals, the transceiver terminates operation while the driver actuates the rotating component to a predetermined position, so as to enable a protective device to shield the window.

2. The LiDAR device according to claim 1, further comprising a locking mechanism, the locking mechanism being configured to lock the rotating component when the rotating component rotates to the predetermined position.

3. The LiDAR device according to claim 2, wherein the locking mechanism comprises a driver, and a retractable rod, the driver comprises a rotor and a stator housing rotatably coupled to each other with the rotor rotating relative to the stator housing under the driver' actuation, and the rotor rotatably coupled to the rotating component, having a locking portion; the driver extends the retractable rod to cooperate with the locking portion to secure the rotating component at the predetermined position.

4. The LiDAR device according to claim 3, wherein the protective device is a plate provided on the LiDAR device to protect the window.

5. The LiDAR device according to claim 3, wherein the driver is a motor, driving the retractable rod to extend or retract along a horizontal direction.

6. The LiDAR device according to claim 3, wherein the locking portion defines a locking groove, when the locking groove is inserted by the retractable rod, the driver stops rotating, causing the rotating component to maintain at the predetermined position.

7. The LiDAR device according to claim 6, wherein the rotating mechanism includes a motor driving the rotating component to rotate when the transceiver is operating, and driving the rotating component to rotate to the predetermined position when the transceiver terminates operation.

8. The LiDAR device according to claim 3, wherein the locking mechanism is disposed within the stator housing.

9. A vehicle, comprising:
a vehicle body;
and a LiDAR device, disposed on the vehicle body, the LiDAR device comprising:
a transceiver, configured to emit primary beams, and detect echo beams formed by the primary beams' reflection from objects;
a rotating component with a window, enabling the transceiver to emit the primary beams outward and receive echo beams through the window;
a driver, rotatably coupled to the rotating component; and
a controller, configured to generate detection signals and locking signals to the driver and the transceiver; wherein:
when the driver and the transceiver receive the detection signals, the transceiver activates operation while the driver driving the rotating component to rotates;
when the driver and the transceiver receive the locking signals, the transceiver terminates operation while the driver actuates the rotating component to a predetermined position, so as to enable the protective device to shield the window.

10. The vehicle according to claim 9, further comprising a locking mechanism, the locking mechanism being configured to lock the rotating component when the rotating component rotates to the predetermined position.

11. The vehicle according to claim 9, wherein the locking mechanism comprises a driver, and a retractable rod, the driver comprises a rotor and a stator housing rotatably coupled to each other with the rotor rotating relative to the stator housing under the driver' actuation, and the rotor rotatably coupled to the rotating component, having a locking portion; the driver extends the retractable rod to cooperate with the locking portion to secure the rotating component at the predetermined position.

12. The vehicle according to claim 11, wherein the protective device is a plate provided on the LiDAR device to protect the window.

13. The vehicle according to claim 11, wherein the driver is a motor, driving the retractable rod to extend or retract along a horizontal direction.

14. The vehicle according to claim 11, wherein the locking portion defines a locking groove, when the locking groove is inserted by the retractable rod, the driver stops rotating, causing the rotating component to maintain at the predetermined position.

15. The vehicle according to claim 14, wherein the rotating mechanism includes a motor driving the rotating component to rotate when the transceiver is operating, and driving the rotating component to rotate to the predetermined position when the transceiver terminates operation.

16. The vehicle according to claim 11, wherein the locking mechanism is disposed within the stator housing.

17. The vehicle according to claim 9, wherein the protective device is a part of the vehicle body or a plate provided on the LiDAR device.

18. A LiDAR device, comprising:
a transceiver, configured to emit primary beams, and detect echo beams formed by the primary beams' reflection from objects;
a rotating component with a window, enabling the transceiver to emit the primary beams outward and receive echo beams through the window;
a driver, rotatably coupled to the rotating component;
wherein when the transceiver terminates operation, the driver actuates the rotating component to a predetermined position, so as to enable a protective device to shield the window.

19. The LiDAR device according to claim 18, wherein the LiDAR device is applied to a vehicle, the protective device is a part of the vehicle body.

20. The LiDAR device according to claim 18, further comprising a locking mechanism, the locking mechanism being configured to lock the rotating component when the rotating component rotates to the predetermined position.
